(19) United States
(12) Patent Application Publication
(10) Pub. No.: US 2005/0114385 A1
(43) Pub. Date: May 26, 2005

(54) Information objects

(76) Inventors: Dai-Kyu Kim, Chatswood (AU); Loke K. Han, Singapore (SG)

Correspondence Address: DARBY & DARBY P.C., P. O. BOX 5257, NEW YORK, NY, 10150-5257, US

(21) Appl. No.: 10/934,303

(22) Filed: Sep. 3, 2004

Related U.S. Application Data
(63) Continuation of application No. PCT/AU03/00259, filed on Mar. 5, 2003.

(30) Foreign Application Priority Data
Mar. 6, 2002 (AU) PS 0862

(51) Int. Cl. G06F 7/00

(52) U.S. Cl. 707/102

(57) ABSTRACT

The present invention provides a method of using a processor to create a linked information object the information object being formed from content having a respective type. The processor is coupled to a display and a store, to allow the processor to obtain an information object and assign a unique identifier thereto in accordance with the information object type. One or more links are then defined between the information object and one or more other information objects, either using predetermined rules, or input commands from a user. The computer then generates link data defining the one or more links, which is stored in the store.

### CROSS-REFERENCE TO RELATED APPLICATION

This application is a continuation of International patent application Serial No. PCT/AU03/00259 filed Mar. 5, 2003, which claims the benefit of Australian patent application Serial No. PS 0862, filed Mar. 6, 2002, which are hereby incorporated by reference in their entirety.

### BACKGROUND OF THE INVENTION

The present invention relates to a method and apparatus for creating and handling linked information objects.

Description of the Prior Art

The reference to any prior art in this specification is not, and should not be taken as, an acknowledgement or any form of suggestion that the prior art forms part of the common general knowledge.

The following recent developments in computing, and the Internet, the amount of information, such as e-mails, that need to be handled on an every day basis is rapidly increasing. Finding, organising and managing this information takes an increasing amount of time. This is exacerbated by the fact that, these pieces of information typically exist in different applications, in different computers, handheld and mobile devices, servers, networks and the like. Furthermore, it is still very difficult to publish, exchange or share information while retaining the structure of the information to be shared. For example, when a file is received by e-mail, the file may need to be organised in a relevant folder, renamed, and/or associated with a particular project, task or group. However, once this has been completed, it is often the case that the reason for the original associations, renaming or the like is forgotten such that there is no longer any manner of telling from where the file originated.

Some attempts have been made to deal with this problem. Thus for example, commenced generating using software applications such as Microsoft Word™ include information regarding the author in a property section. However, this information is typically filed in based on the registration on the software application. Accordingly, if a third party is using the software application the correct authorship of the document is not necessary indicated. In addition to this, this information can not be used to create associations, such as relationships between documents.

Some application software, such as Microsoft Outlook™ use folder to allow received e-mails to be sorted into categories. Thus for example, a business can organise so that e-mails received from a particular client are stored in a particular folder. However, the folders can oily be adapted to store e-mails and accordingly, other related files, such as attachments must be stored in a separate directory structure. This means respective directory structures tend to be generated for different applications. As a result, there is no relationship other than the naming of the directories and folder that can relate the files to a common source.

In addition to this, the use of folders and directories is typically a manual process that requires that the folders and directories are constructed and used manually. Accordingly, the structure used is typically intuitive to the creator of the structure and may therefore not be readily understood by third parties.

Finally, a respective directory structure would typically have to be stored either on a server, or on each machine individually. However, this would not typically allow common directory structure to be utilised across different and connected networks. Thereby creating further problems in the organisation in the files contained therein.

Thus data may be stored as application centric data, which is managed according to the application that creates it, or hierarchically in a strict tree like structure with no flexibility.

### SUMMARY OF THE PRESENT INVENTION

In a first broad form the present invention provides a method of using a processor to create a linked information object, the processor being coupled to a display and a store, each information object being formed from content having a respective type, the method including causing the processor to:
a) Obtain an information object;
b) Assign a unique identifier to the information object in accordance with the information object type, the information object type being based on the type of the content;
c) Define one or more links between the information object and one or more other information objects, the links being defined using at least one of:
   i) Predetermined rules; and,
   ii) Input commands from a user;
d) Generate link data defining the one or more links; and,
e) Store the link data in the store.

Typically the method of obtaining the information object includes causing the processor to obtain an information object by determining a new information object from a data object by:
a) Obtaining the data object, the data object including one or more content type instances;
b) Determining a content type instance from the data object;
c) Comparing the content type instance to existing information objects; and,
d) Determining the content type instance to be a new information object in response to an unsuccessful comparison.

If the data object contains two or more information objects, the method of defining the one or more links between the information object and one or more other information objects usually includes defining links between the information objects contained in the data object.

The method of defining the one or more links between the information object and the other information objects, typically includes causing the processor to:
a) Compare the information object type of the information object with the information object type of each other information object in accordance with predetermined rules; and,
b) Define a link between the information object and one of the other information object in accordance with a successful comparison.

Preferably the predetermined rules specify for each information object type respective conditions that must be satisfied in order to allow the link to be defined with other information object types.

Typically one of the conditions includes that a link is defined between two information objects having respective first and second information object types if the content of one of the information objects is formed from a portion of the content of the other information object.

The method of defining the one or more links between the information object and one or more other information objects, typically includes causing the processor to:
a) Display a representation of the information objects to the user;
b) Allow the user to use an input to select at least two of the information objects; and,
c) Define a link between the selected information objects.

The method of displaying a representation to the user usually includes causing the processor to:
a) Determine the identifiers of any information objects to be displayed;
b) Determine any links between the information objects, the links being determined in accordance with the determined identifiers and the link data; and,
c) Generate a representation of the information objects by:
   i) Generating a representation of each information object based on at least one of the information object type and the information object content; and,
   ii) Generating a representation of the determined links between the information object representations.

The representation may be formed from any representation, although preferably the representation is a tree type representation, with the information object representations being arranged in accordance with the determined links.

The information object identifier typically further includes an indication of the respective processing system on which the information object was determined.

The processor is usually adapted to execute information object processing applications software adapted to allow user to process selected information object types, the method typically including causing the processing application to perform at least one of the following processes:
a) Define new information objects; and,
b) View the contents of selected information objects.

The processor is usually also adapted to execute display application software adapted to display information objects.

The processor can be further adapted to execute control application software adapted to cooperate with the display software and one or more of the processing applications.

The method usually includes controlling the determination of new information objects by causing the control application to:
a) Obtain the data object;
b) Determine the content type of one or more content instances from the data object; and,
c) Transfer the information object to a processing application adapted to process the determined content type.

The method typically includes controlling the determination of the identifiers by causing the control application to:
a) Obtain a new information object from a respective processing application; and,
b) Generate the identifier in accordance with predetermined rules, and in accordance with the information object type.

The method usually further includes causing the control application to perform at least one of:
a) Defining the links between information objects;
b) Transferring the information objects to the display application to cause the information objects to be displayed; and,
c) Obtaining processing applications to allow different information object types to be processed.

The method generally further includes define relationships, each relationship defining a context for links between specified information object types, each relationship being defined by causing a respective processing application to:
a) Allow a user to select two or more object types;
b) Allow the user to specify a relationship for links between the selected object types; and,
c) Store an indication of the relationship as relationship data.

In a second broad form the present invention provides a processing system for creating a linked information object, the processing system including:
a) A display;
b) A store;
c) A processor adapted to perform the method of the first broad form of the invention.

In a third broad form the present invention provides a computer program product for creating a linked information object, the computer program product including computer executable code which when executed on a suitable processing system causes the processing system to perform the method of the first broad form of the invention.

The computer program product may be provided as self contained applications software, or may alternatively be implemented as a plug-in for existing software applications.

In a fourth broad form the present invention provides a method of using a processor to handle linked information objects, the processor being coupled to a display, a store and an input, each information object being formed from content having a respective type, the links between the information objects being defined by link data stored in the store, the method including causing the processor to:
a) Generate a representation of a number of information objects, the representation being displayed to the user on the display;
b) Allow the user to use the input to select one of the information objects;
c) Determine one or more other information objects linked to the selected information object in accordance with the link data; and,
d) Generate a representation of the selected information object and at least the linked information objects, the representation being displayed on the display.

The method usually further includes causing the processor to generate the representation by:
a) Determining the identifier of the selected information object;
b) Determining the links between the selected information object and the linked information objects, the links being determined in accordance with the determined identifier and the link data; and,
c) Generating the representation by:
   i) Generating a representation of each information object based on at least one of the information object type and the information object content; and,
   ii) Generating a representation of the determined links between the information object representations.

The representation may be formed from a tree type representation, with the information object representations being arranged in accordance with the determined links.

The processor can be further adapted to display the content of an information object to be displayed on the display in response to a request from a user.

The processor, the display, the store and the input typically form part of a processing system. In this case, the processing system can be adapted to be coupled to one or more other processing systems via a communications network, the method including causing the processor to obtain required data from other ones of the processing systems, the required data including at least one of:
a) Information objects;
b) Link data; and,
c) Information object identifiers.

The identifiers typically include an indication of the processing system on which the identifier is stored, the method further including causing the processor to:
a) Determine the processing system on which the required data is stored; and,
b) Obtain the required data therefrom.

The link data typically specifies the identifiers of each linked information object for each respective link, the method further including causing the processor to determine the identifier of a linked information object to be obtained from the link data.

The processor can be adapted to execute information object processing applications software adapted to allow user to process selected information object types, the method typically including causing the processing application to perform at least one of the following processes:
a) Define new information objects; and,
b) View the contents of selected information objects.

The processor can be adapted to execute display application software adapted to display information objects.

The processor can also be adapted to execute control application software adapted to cooperate with the display software and one or more of the processing applications.

In this case, the method typically includes controlling the generation of a representation of information objects linked to a selected information object by causing the control application to:
a) Determine the link data representing the respective links in accordance with the identifier of the selected information object;
b) Determine the identifiers of each linked information object from the link data; and,
c) Transfer an indication of the links and the identifiers to the display application.

The method usually also includes controlling the display of the content of a selected information object by causing the control application to:
a) Determine the identifier of the selected information object;
b) Determine if the selected information object is in the store; and,
   i) If not;
      (1) Determine the processing system from which the information object can be obtained; and,
      (2) Causing the processing system to obtain the information object from the determined processing system;
   ii) Otherwise obtain the information object from the store; and,
c) Transfer the information object to a selected processing application, the processing application operating to display the contents of the application.

The processing application is also usually further adapted to define relationships, each relationship defining a context for links between specified information object types, the method including:
a) Allowing a user to select a relationship type; and,
b) Controlling the generation of the representation such that only links satisfying the selected relationship are displayed.

The method typically further includes causing the control application to:
a) Determine the information object type from the respective identifier;
b) Determine if any processing applications executable by the processor can process the determined information object type; and,
c) Causing the processor to obtain a new processing application from one of the other processing systems via the communications systems in response to an unsuccessful comparison.

The linked information objects being created using the method of the first broad form of the invention.

In a fifth broad form the present invention provides a processing system for handling linked information objects, the processing system including:
a) A display;
b) A store;
c) A processor adapted to perform the method of the fourth broad form of the invention.

In a sixth broad form the present invention provides a computer program product for handling linked information objects, the computer program product including computer executable code which when executed on a suitable processing system causes the processing system to perform the method of the fourth broad form of the invention.

Again, the computer program product may be provided as self contained applications software, or may alternatively be implemented as a plug-in for existing software applications.

### BRIEF DESCRIPTION OF THE DRAWINGS

An example of the present invention will now be described with reference to the accompanying drawings, in which:—

FIG. 1 is a schematic diagram of an example of a system for implementing the present invention;

FIG. 2 is a schematic diagram of an example of one of the processing system of FIG. 1;

FIG. 3 is a schematic diagram of an example of one of the end stations of FIG. 1;

FIG. 4 is a schematic diagram showing the functionality of FIG. 1;

FIGS. 5A and 5B are screen shots of examples of the UIM of FIG. 4;

FIG. 6 is a flow chart of an example of the process of defining an information object using the system of FIG. 1;

FIG. 7 is a flow chart of an example of the process for linking information objects using the system of FIG. 1;

FIG. 8 is a flow chart of an example of the process for pivoting around an information object using the system of FIG. 1;

FIG. 9 is a flow chart of an example of the process for displaying relationships using the system of FIG. 1; and,

FIG. 10 is a flow chart of an example of the process for viewing the content of an information object using the system of FIG. 1.

### DETAILED DESCRIPTION OF THE PREFERRED EMBODIMENTS

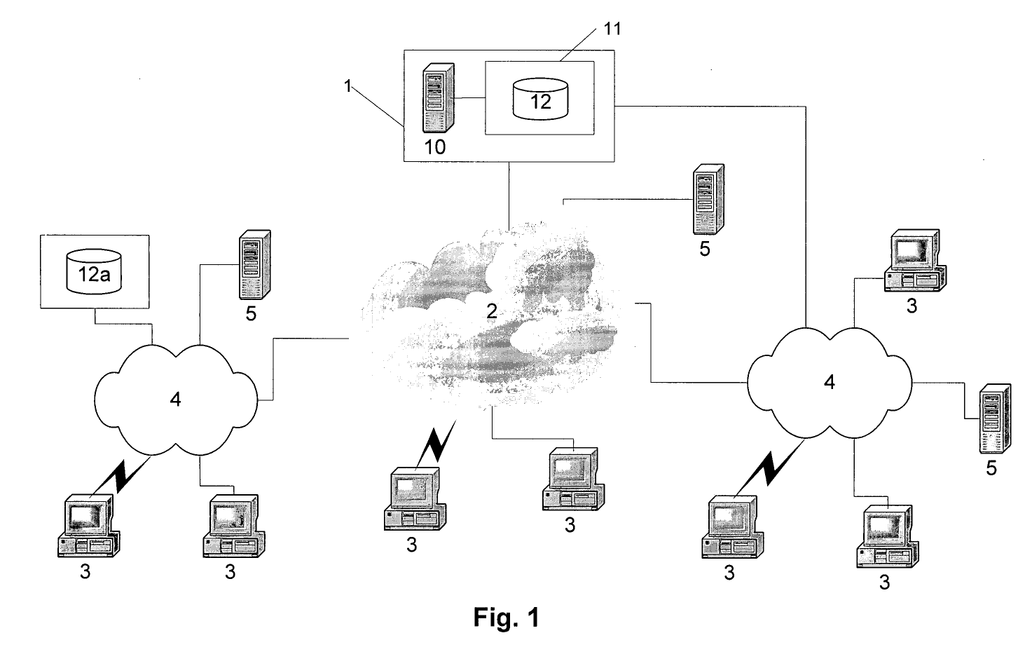

An example of the present invention will now be described with reference to FIG. 1, which shows a system suitable for implementing the present invention.

As shown, the system includes one or more base stations 1 (of which only one is shown for clarity) coupled to a number of end stations 3, via a communications network 2, and via a number of local area networks (LANs) 4.

The base station 1 is generally formed from one or more processing systems 10 coupled to a data store 11, the data store 11 usually including a database 12, as shown. In addition to this, a database 12A may also be provided coupled to the LAN 4, as will be described in more detail below. Additionally, one or more servers 5 may be coupled to the communications network 2, and/or the LANs 4 as shown.

In use, users of the end stations 3 can access services provided by the base stations 1, allowing the users to view details of and interact with information objects (IOs) stored within the system. An IO is a piece of data of a respective type that is described within the system in a predetermined manner. The IO may therefore correspond to any type of content such as e-mails, e-mail addresses, “Word” documents, invoices, or any other data the content of which can be defined to have a specific type.

This functionality is achieved by allowing users to share IOs between the end stations 3, the servers 5, and the base stations 1, in accordance with certain predefined permissions. The IOs are also linked to each other, to allow users to browse related IOs, thereby aiding navigation between the objects.

Accordingly, it is necessary for end station 3 and the base station 1 to be able to communicate to allow data such as IOs and other details to be transferred therebetween.

It will therefore be appreciated that the system may be implemented using a number of different architectures. However, in this example, the communications network 2 is the Internet, with the LANs 4 representing private LANs, such internal LANs within a company or the like.

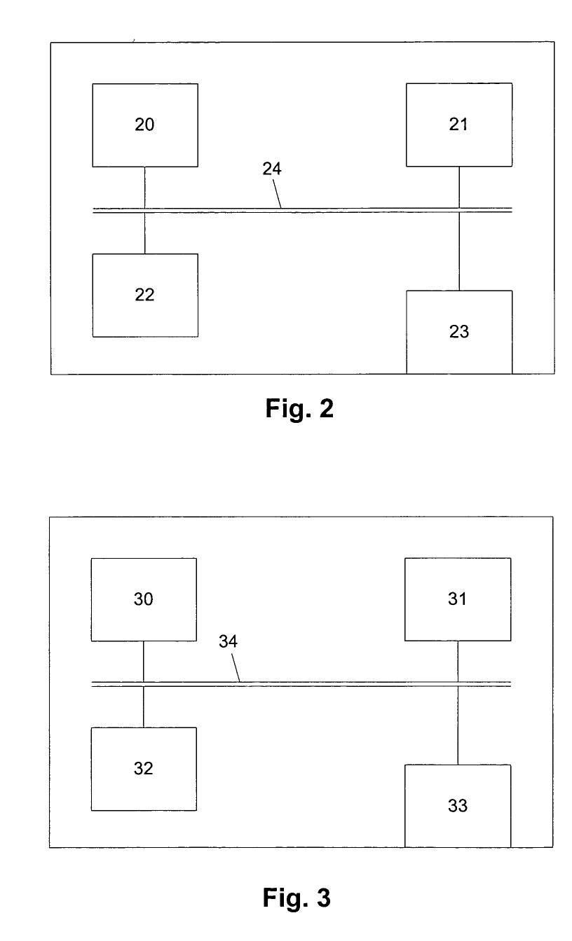

Accordingly, the processing systems 10 may be any form of processing system but typically includes a processor 20, a memory 21, an input/output (I/O) device 22 and an interface 23 coupled together via a bus 24, as shown in FIG. 2. The interface 23, which may be a network interface card, or the like, is used to couple the processing system to the Internet 2, and optionally the LAN 4.

It will therefore be appreciated that the processing system 10 may be formed from any suitable processing system, which is capable of operating applications software to enable the provision of the required services. However, in general the processing system 10 will be formed from a server, such as a network server, web-server, or the like.

It will therefore be appreciated that the servers 5 may have a similar structure.

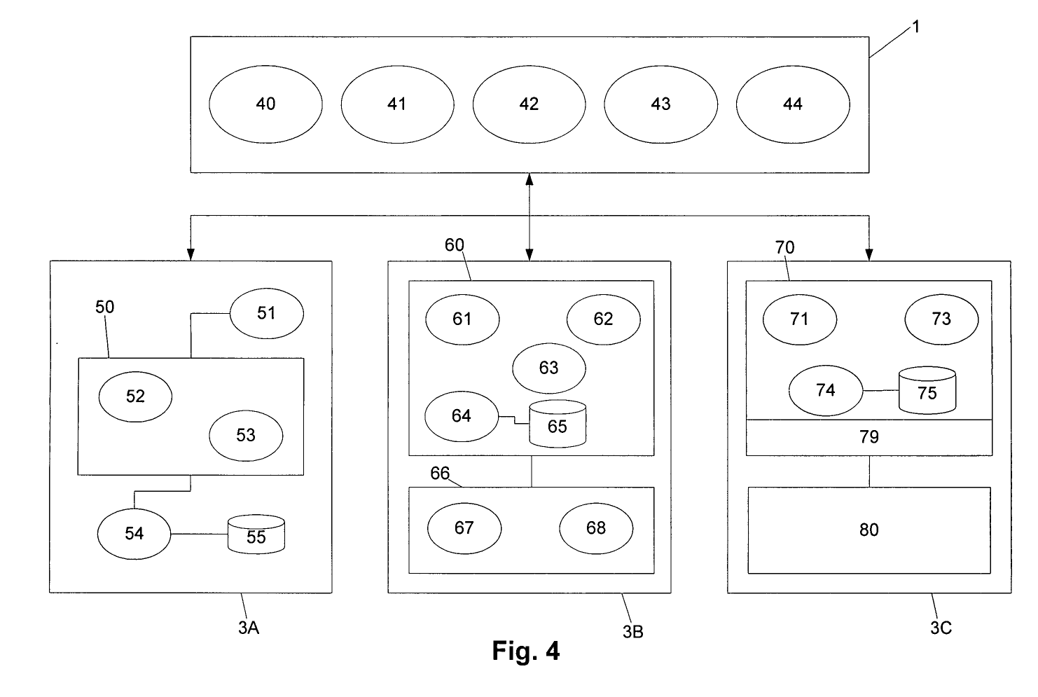

Similarly, the end stations 3 must be capable of co-operating with the base station 1, and in particular communicating with the processing system 10, to send or receive data including IOs. Similarly communication with the servers 5 may also be required. Accordingly, in this example, as shown in FIG. 3, the end station 3 is formed from a processing system including a processor 30, a memory 31, an input/output (I/O) device 32 and an interface 33 coupled together via a bus 34. The interface 33, which may be a network interface card, or the like, is used to couple the end station 3 to the Internet 2.

Accordingly, it will be appreciated that the end stations 3 may be formed from any suitable processing system, such as a suitably programmed PC, Internet terminal, lap-top, hand-held PC, or the like, which is typically operating applications software to enable data transfer and in some cases web-browsing.

In the case in which the IOs are e-mail or the like, the processor 30 may operate specialised applications software created specifically for processing the defined IOs. Alternatively the processor may operate modified versions of existing e-mail or other applications, such as Microsoft Outlook™, which have been modified to provide services in accordance with the invention. This could be achieved for example by the provision of plug-ins that allow existing applications software to achieve the required functionality.

Alternatively, the end station 3 may be formed from specialised hardware, such as an electronic touch sensitive screen coupled to a suitable processor and memory, as described in more detail below. In addition to this, the end station 3 may be adapted to connect to the Internet 2, or the LANs 4 via wired or wireless connections. It is also feasible to provide a direct connection between the base stations 1 and the end stations 3, for example if the system is implemented as a peer-to-peer network.

Overview

As briefly mentioned above, the present invention provides techniques for allowing users to view IOs and associated links using the end stations 3. The manner in which this is achieved will now be briefly described.

Firstly, it is necessary for the IOs to be defined within the system.

As mentioned above, each IO represents content of a respective type that is described within the system in a predetermined manner. Accordingly, to create the IO it is necessary to first determine the respective content and then generate an appropriate definition.

The user can create the content using specialised software applications. Alternatively, the content can be determined from a data object, such as a file, an e-mail, or the like which is received at the end station 3. The data object may contain several different content instances, some of which may have different types and accordingly, the first process is for the end station 3 to analyse the data object and determine any content instances contained therein.

Thus, for example, in the case of an e-mail, the e-mail itself is an instance of e-mail type content. Similarly, the sender's and the recipient's e-mail addresses are also respective instances of e-mail address type content. It is also possible for the e-mail to include one or more attachments, and again, each of the attachments may be a respective instance of a particular type of content.

Having identified all the different content instances, the end station 3 will proceed to define each content instance as an IO by assigning a respective identifier to each one of the content instances. The end station 3 assigns the identifier in accordance with predetermined criteria. Accordingly, the identifier of each IO generally depends on at least:
The IO type;
The identifier of the end station 3 assigning the identifier.

This allows each content instance to be defined as a respective IO, with the type of the IO depending on the type of the respective content. Thus for example, an e-mail IO would typically correspond to the e-mail content of the e-mail. Similarly, the e-mail address IO will correspond to a respective e-mail address within the e-mail.

This allows each IO to be uniquely defined, as well as allowing the IO type and IO source to be identified.

Once an IO has been defined, this can then be linked to other IOs defined within the system of FIG. 1. These other IOs may either be stored on the respective end station 3 or, alternatively, be stored elsewhere on the system. Thus, for example, the other IOs could be stored on the base station 1, in the database 12, the database 12A, or on any one of the other end stations 3, or in one of the servers 5.

The links between the IOs may be defined either automatically in accordance with predetermined rules and/or manually by a user.

A definition of each defined link is then created, with the link definition being generally, stored together with the defined IO identifiers either within the base station 1, the database 12, the database 12A, one of the servers 5, or within a respective one of the end stations 3.

In use, users of the end stations 3 are therefore able to view IOs using the end stations 3 themselves. This is achieved by having the end station 3 generate a representation of a selected IO, together with any other IOs which are linked thereto.

In order to achieve this, the end station 3 is adapted to receive an indication of an IO to be viewed. The end station 3 will then use the identifier of the respective IO to locate link data defining any associated links. The link data is used by the end station 3 to determine the identifiers of the linked IOs, allowing representations of the links and IOs to be determined. This information can then be displayed to the user.

In general, the procedure of selecting an IO and then viewing any additional IOs linked thereto is known as “pivoting” around the IO. This procedure will allow users to navigate around linked IOs allowing a user to find any desired IOs. Once this has been achieved, the content of the IO can be viewed or modified as required.

Thus, it will be appreciated that this allows IO's of any type to be linked in a flexible hierarchy independent of any predefined hierarchy structure and independent of the applications used to handle the IO's.

As set of IOs which are linked together are commonly referred to as a pivot universe, and accordingly, it is possible for users to navigate through the IOs contained in a universe solely by using the defined links.

In general, users of the system will want to define their own universes, as well as viewing publicly available universes. In order to allow a user to control access to their own private universe, users can define access rights to their own universe. Each user of the system is then provided with respective access rights depending on their own access privileges. This allows users to restrict access to their universe to selected individuals or entities. In this instance only those individuals or entities with access to a universe can view or pivot around the IO's contained therein.

Thus, for example, companies may wish to retain their own IOs confidential so that they cannot be viewed by users of the system that do not form part of their respective company, or are not an authorised client. Similarly, however, this also allows universal access rights to be granted to selected pivot universes, for example, allowing global address books to be implemented.

However, in general common IOs will link user's universes to each other. Thus for example, first and second users may each have a respective universe formed from various linked IOs. In the event that the first user receives e-mail from a second user, the first user's universe can to be updated to include an e-mail address IO based on the second user's e-mail address. However, the second user's universe will also include an e-mail address IO based on the second user's e-mail address.

Accordingly, it will be appreciated that the system can be adapted to determine that these e-mail address IOs are identical. Accordingly, when either user is pivoting around this common e-mail address IO, the user will be able to view links to IOs contained in both the universes, assuming appropriate access rights are provided.

Accordingly, it will be realised that unless a universe is specified as being private, and has corresponding restricted access, then any user of the system can view the IOs contained therein.

This has many benefits, in particular as it allows the information available on the system to be freely viewed. Thus for example, the first user could obtain e-mail addresses from the second user's universe if the universe is defined as public.

### DETAILED DESCRIPTION

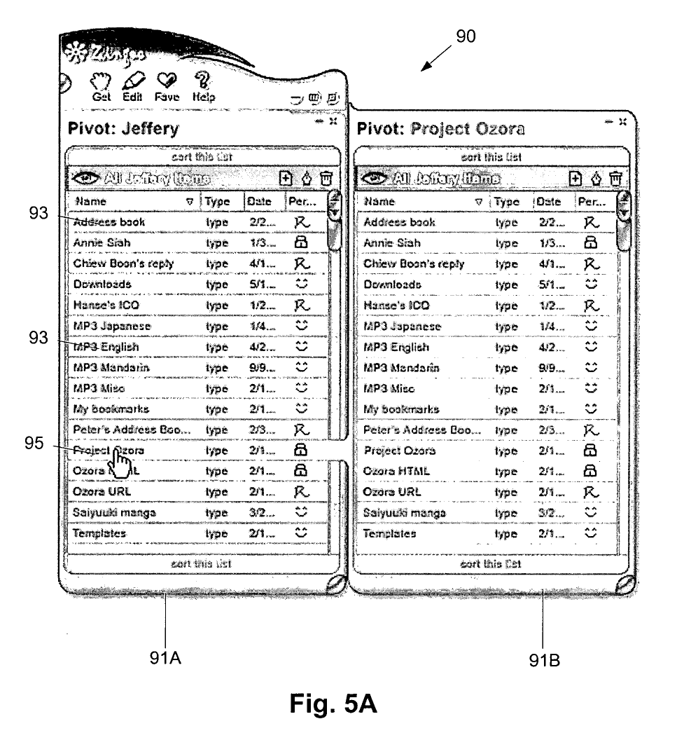

A detailed description of operation of the system of FIG. 1 will now be described. In particular, the functionality of the system of FIG. 1 will be described in more detail with respect to FIG. 4.

As shown in FIG. 4, the system can be implemented using a number of different techniques. In each case, however, the base station 1 operates to provide a certain number of services, including an authentication service 40, an identifier service 41, an address mapping service 42, a global objects service 43 and a global pivot service 44.

Each of the end stations 3 will then operate a selected one or more of the functionality's shown at 3A, 3B, 3C.

In this example, the end station 3 having functionality shown at 3A is adapted to operate in a peer-to-peer network environment, with the functionality shown at 3B representing a client-server application, and the functionality shown at 3C representing a web-server application.

In peer-to-peer (p2p) mode of operation, the end station 3 operates a pivot service 51, which is coupled to a user interaction manager (UIM) 50. The UIM 50 operates to control the operation of a pivot client manager 52, and an object interaction engine (OIE) manager 53. In use, the UIM 50 is optionally coupled to a database manager 54 and a database 55, as shown.

In the client server functionality shown at 3B, the end station 3 operates a service manager shown generally at 60, which implements a pivot service 61, a pivot clients manager 62 an OIE manager 63, a database manager 64, and a database 65, as shown. In addition to this, coupled to the service manager 60 is a clients manager 66 which implements a further pivot clients manager 67 and a further OIE manager 68.

Finally, in the web service application functionality shown at 3C, a web server application is provided at 70 which implements a pivot service 71, an OIE manager 73, a database manager 74 and a database 75. In use, the web server application is coupled via a web server 79 to a web client 80, such as a web browser or the like.

The functionality of each of core services 40, 41, 42, 43, 44 operated by the base station 1 will now be outlined below.

Authentication Service 40

The authentication service 40 provides an authentication mechanism for users of the system. This allows access to the system to be controlled to registered users or the like, as well as allowing a mechanism for controlling access restrictions based on user permissions, as will be described in more detail below.

Identity Service 41

The identifier service 41 keeps track of the unique identifiers used by the system, thereby allowing information, IOs, OIEs and services to be uniquely identified.

Address Mapping Service 42

The address mapping service 42 maintains a dynamic map of currently networked and reachable applications. This map is updated constantly when applications go on-line or off-line.

Global Object Service 43

The global object service 43 is the main registration and distribution point for certified OIEs. Accordingly this is used to allow users of the end stations 3 to download OIEs as required.

Global Pivot Service 44

The global pivot service 44 contains IOs and links of the publicly available universes.

P2P Operation

The p2p functionality operates by:
Storing IOs locally
Providing a dynamic address map
Providing non-persistent connectivity and access to locally stored IOs
   As described above, the p2p model includes the following components:
p2p Pivot Service 51
p2p UIM 50
p2p database manager 54 (optional)

The functionality of each of these component operated by the end station 3 in the p2p functionality 3A will now be outlined below.

P2P Pivot Service 51

The pivot service 51 act as a communications module within the p2p framework. The pivot service 51 will handle all communications between the core services 40, 41, 42, 43, 44 of the base station 1, and the components operated by the other end stations 3 operating in accordance with any of the functionalities (i.e. p2p, client/server or web-server). This includes operations such as:
Identity and Authentication
Requests for IOs
Requests for link definitions
Transfers of OIEs
   P2P UIM 50

The UIM 50 is the interface that is presented to the user. The UIM 50 is in charge of presenting IOs and the associated links to the user of the end station 3 via a graphical interface. This allows users to manipulate IOs defined within the system.

The UIM 50 includes two components, namely:
Pivot Clients Manager 52
Object Interaction Engines Manager 53

The pivot clients manager 52 basically allows users to choose from a list of user interfaces that help users manage IOs, links and relationships. The pivot clients manager 52 can therefore be tailored to specific requirements and distributed across the system allowing users to select preferred pivot clients from those available.

The OIE manager 53 manages the different types of OIEs available to handle the different IOs types in the system. An OIE pertaining to IO types will be responsible for representing the content of the IO to the user of the end station 3.

P2P Database Manager 54

The p2p database manager 54 is an optional component that allows database owners to link up their databases 55, as well as create new databases 55 to store IOs, link data, IO identifiers, and the like. This provides users with flexibility in data storage.

Client-Server Operation

The client-server functionality provides for storing data centrally in a persistent server, and accessing the data with non-persistent clients. In this model, access to a pivot universe is done through the server and only through the server.

This model consists of 2 main components:
Service Manager 60 (which forms the server)
Client Manager 66 (which forms the client)
   Service Manager 60

The service manager 60:
Is a persistent service and is permanently connected to the base station 1
Has a persistent database 65 for storing IO data
Manages local pivot information
Handles all communications with non-local services, such as the core services of the base station 1

It will therefore be appreciated that the service manager 60 may be implemented either as part of the base station 1 itself, or alternatively as a processing system coupled to one of the LANs 4, for example. Thus in the case of a company, or the like, the service manager would typically be implemented on a central server, with the users of respective end stations 3 operating to access the central server to obtain onward connectivity to services provided by the base station 1.

It consists of the following components:
Pivot service 61
Pivot clients manager 62
OIE manager 63
Database manager 64
   Pivot Service 61

The pivot service is the communications module within the client server framework and handles all communications between the core services 40, 41, 42, 43, 44 of the base station 1, and the components operated by the other end stations 3 operating in accordance with any of the functionalities. This includes operations such as:
Identity and Authentication
Requests for IOs
Requests for link definitions
Transfers of OIEs
   OIE Manager 63

This component manages all the OIEs that the client server functionality supports.

Pivot Clients Manager 62

This component manages the pivot clients that are available for use in the client server functionality.

Database Manager 64

The database manager handles all IO data and stores it in the database 65 as required.

Client Manager 66

The client manager 66 is the main interaction interface with the user, and generally consists of:
Pivot Clients Manager 67
Object Interaction Engines Manager 68
   The Pivot Clients Manager 67 Displays and Allows Users to Manipulate IOs, Links and the Like.
   The OIE Manager 68 Component Manages the OIEs that are Available for Use in the Client Server Framework.
   Web-Server Operation

The web-server functionality deploys over a web server application framework. Users therefore interact with the system via web browsers executed by their respective end station 3.

The web-server functionality can be implemented, for example, using JSP/Java Servlet technology, and generally operates using the following components:
Pivot Service 71
OIE Manager 73
Database Manager 74
JSP/Java Servlet capable Web Server 79
Web client/browser 80
   Pivot Service 71

The pivot service is the communications module within the client server framework and handles all communications between the core services 40, 41, 42, 43, 44 of the base station 1, and the components operated by the other end stations 3 operating in accordance with any of the functionalities. This includes operations such as:
Identity and Authentication
Requests for IOs
Requests for link definitions
Transfers of OIEs
   OIE Manager 73

This component manages all the OIEs that the web server functionality supports.

Database Manager 74

Handles all the IO data, and controls the storage in the database 75.

JSP/Java Servlet Capable Web Server 79

This operates as a web-server providing access to the required services for the user, via the web client or browser 80. The web server is therefore typically operated as part of the base station 1, although may alternatively be operated by a processing system coupled to one of the LANs 4, for example, which can then provided onward connectivity to the base station 1.

Thus in the case of a company, or the like, the web server application 70 and the web server 79 would typically be implemented on a central server, with the users of respective end stations 3 operating to access the central server to obtain onward connectivity to services provided by the base station 1.

Web Client/Browser 80

A web browser is required to access the data from the web servers 79. This is the interaction platform for users of the web-server functionality.

It will be realised that the functionality outlined above, and in particular the functionality achieved on the user's end stations 3 may be achieved using specialised applications software. Alternatively, the functionality may be achieved for example by providing software plug-ins that act as an interface with existing applications software to allow the existing applications software to perform the required functionality.

Operation of the system to define IOs with associated links and to navigate through the pivot view universes will now be described with respect to the peer-to-peer functionality. It will, however, be appreciated that equivalent operation will be obtained using either the client server or the web server functionality.

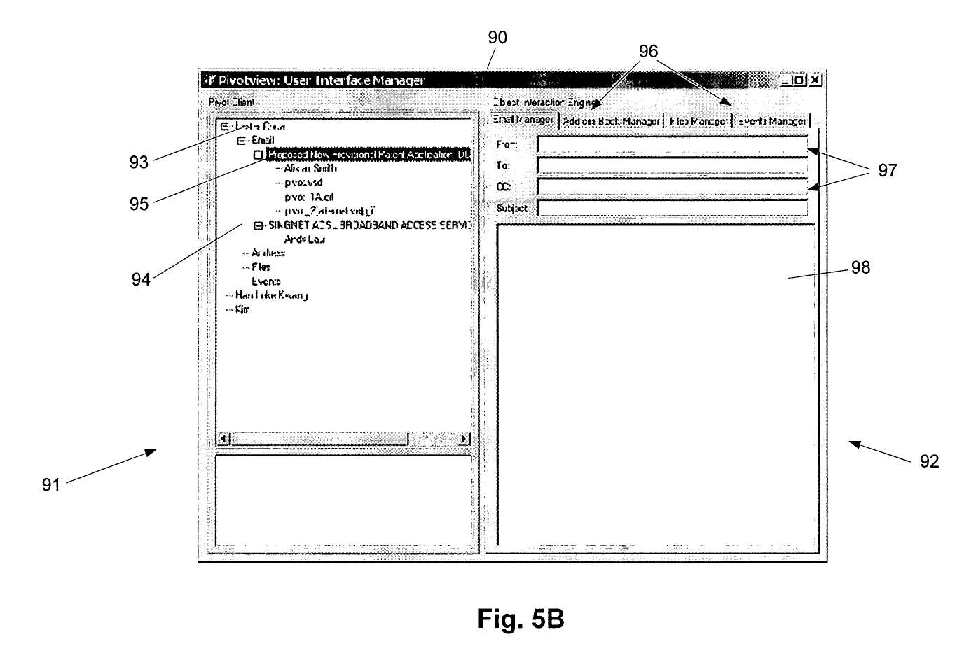

FIGS. 5A and 5B, which will be discussed in more detail below, shows examples of graphical representation of the screens presented to user of one of the end stations 3. In the p2p case, this is achieved by the UIM 50, whereas in the client and web server functionality's, this would be achieved by the client manager 66, and the web server 80, respectively.

In FIG. 5A, the UIM 50 is shown generally at 90, with two pivot client windows being shown at 91A, 91B. In this example, the pivot clients window 91A lists a number of IOs at 93. When the user pivots around a selected IO 95, the IOs linked thereto are displayed in the second pivot clients window 91B.

In the example of FIG. 5B, the user is presented with a graphical representation of a UIM, shown generally at 90, which allows content of IOs to be viewed. In this case, the UIM 90 presents the user with two main windows namely a pivot clients window 91, and a OIE window 92.

As will be described in more detail below, the pivot client window is used by a respective pivot client to display representations of IOs as shown at 93, and of links as shown at 94, in the window 91. A selected IO is also shown at 95.

Similarly, the UIM 50 allows a user to select different OIEs using the selection tabs shown at 96. In use, the selected OIE will then be presented in the OIE window 92. In this example, the OIE is an e-mail OIE that is adapted to allow users to view the content of, and generate e-mail IOs. This may achieved by providing applications software that forms the OIE. Alternatively, the OIE may be implemented as a plug-in for existing applications software. Thus for example, the e-mail OIE may be implemented as a plug-in for existing e-mail packages such as Microsoft Outlook, or the like. In this case, the user will either be redirected to Outlook to produce an e-mail IO, or will be presented with Outlook in the OIE window 92.

In any event, assuming that an e-mail OIE is displayed in the OIE window, then the OIE window will include fields shown generally at 97 allowing a user to enter e-mail options, with a window 98 being provided to allow e-mail text to be defined. Otherwise, equivalent fields in Microsoft Outlook or equivalent would be used.

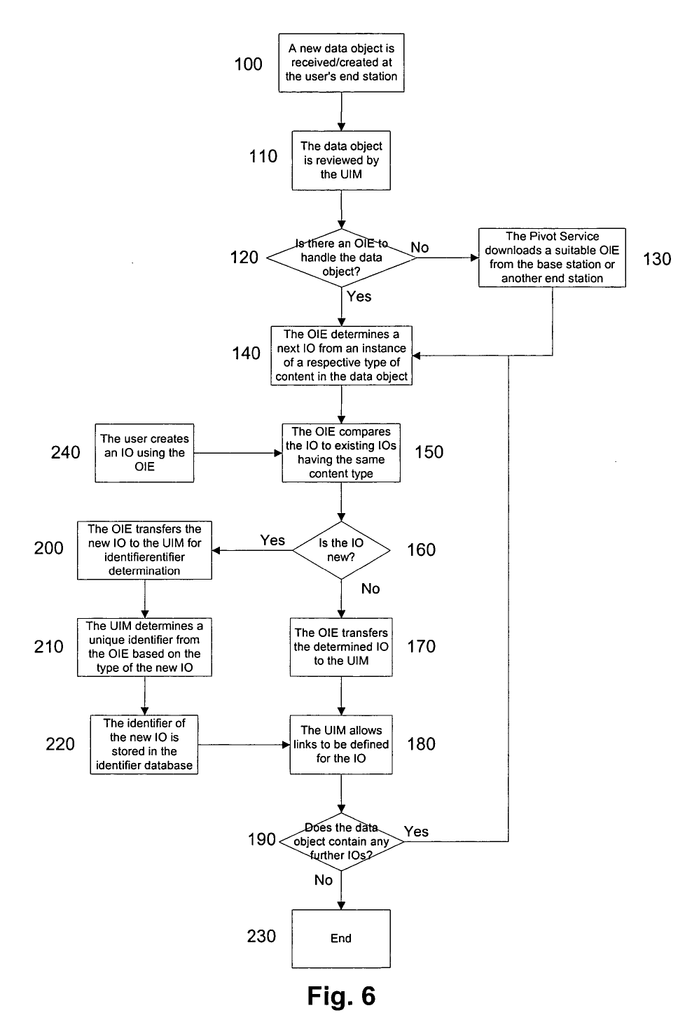

The procedure for defining an IO will now be described with reference to FIG. 6. The manner in which this is achieved will vary depending on whether the IO is created directly using one of the OIEs, or whether the IO is extracted from a data object received or created at the end station 3.

In the later case, a new data object is received or created at the user's end station 3 at step 100. This may therefore be, for example, an e-mail received via the Internet 2, or may alternatively be an e-mail created on the users end station 3 using e-mail software which does not interact with the UIM 50.

In any event, once received the data object is reviewed by the UIM 50 at step 110 allowing the UIM 50 to determine the type of content contained in the data object. At step 120, the UIM 50 determines whether an OIE is available that is capable of handling the data object, and in particular, the determined content type. Thus, the UIM 50 queries the OIE manager 53 to examiner the OIEs currently available to determine if one of these is capable of handling the respective IO type. In general, the currently available OIEs would be stored in the database 55, or in the memory 31 of the end station 3, although this is not essential.

Thus, for example, if the UIM 50 determines that the data object is an e-mail, the UIM 50 will query the OIE manager 53 to determine if an e-mail OIE exists. If not, a suitable OIE is downloaded from either the base station 1 or another one of the end stations 3 via the pivot service 51, as shown at step 130.

At step 140, once a suitable OIE is available, the OIE operates to determine a next 10. This is achieved by having the OIE identify instances of a respective type of content within the data object. Thus, for example, if the data object is an e-mail, the OIE will first operate to determine an e-mail IO representing the e-mail as a whole.

The OIE will then compare the determined IO to existing IOs having the same content type. Thus, the OIE will operate to compare the identified e-mail IO to existing e-mail IOs stored on the system. If an identical IO already exists, as determined at step 160, then the OIE will transfer the determined IO to the UIM 50 at step 170. The UIM 50 proceeds to allow links to be defined for the IO at step 180, before proceeding to determine if further IOs exist within the data object at 190.

If, however, the IO is determined to be new at step 160, the OIE transfers the new IO to the UIM 50 for identifier determination at step 200. At step 210, the UIM 50 determines a unique identifier from the OIE based on the type of the new IO. The actual format of the identifier can vary depending on the implementation of the system. However, in this example, the identifier is based on a pivot service identifier, an interaction engine identifier, a template identifier and an object identifier.

The pivot service identifier is an identifier that is unique to the respective pivot service 51 operated by the respective end station 3. The pivot service identifier is issued by the identifier service 41 and is used to allow the respective end station 3 generating the IO to be identified.

The interaction engine identifier is an identifier that is unique to the relevant OIE that generates the IO. Again, this allows the respective OIE used to generate an IO to be determined.

The template identifier and object identifier are both issued by the OIE. The template identifier is representative of the respective type of content associated with the IO, and accordingly, a respective identifier will be assigned for e-mail type content. The object identifier itself is a unique number assigned to the respective IO instance, and is therefore used to ensure that the identifier issued to each IO is unique.

The identifier of the new IO is then stored in a database at step 220. In general, the identifier will be stored in the database 55 associated with the respective end station 3. However, as the presence of the database 55 is optional, it is also possible to store the identifier in the memory 31, or alternatively, in one of the other end stations 3, in the base station 1, for example in the database 12, in one of the servers 5, or in the database 12A, as appropriate.

In any event, the end station 3 will always operate to store the respective identifiers generated thereon in a respective database, thereby allowing the identifiers to be located subsequently.

It will be realised that in the case of an e-mail data object, it would be typical for the data object to include a number of IOs. This would include, for example, the sender's and recipient's e-mail addresses, each of which will be a respective IO. Accordingly, once the IO has been defined and the UIM 50 has allowed links to be defined for the IO at step 180, the processor 30 will again operate to determine if any further IOs exist. These will then be processed in a similar manner.

Thus it will be appreciated that each e-mail address will be used to define a respective e-mail address IO. Again, when this is performed, each defined IO will be compared to existing IOs at step 150, so that a new IO is not created each time the same e-mail address is received, or each time the sender's e-mail address is used.

Once no further IOs exist, the procedure ends at step 230.

Alternatively, the user may create an IO using a respective OIE. In this case, as the user enters an e-mail address, for example, into one of the e-mail fields 97, the OIE will automatically operate to define this as an IO. The OIE will then proceed to step 150 to determine if the IO is new. The remainder of the procedure is substantially as described above, and will not therefore be described in detail.

It will be appreciated that the above procedure outlines one possible way of defining the IOs, in which each IO is processed sequentially. Alternatively, however, this may be performed in parallel, for example, so that each content type instance is determined. Each IO would then be supplied with an identifier, before each IO is processed to allow links to be defined. Other variations are also possible.

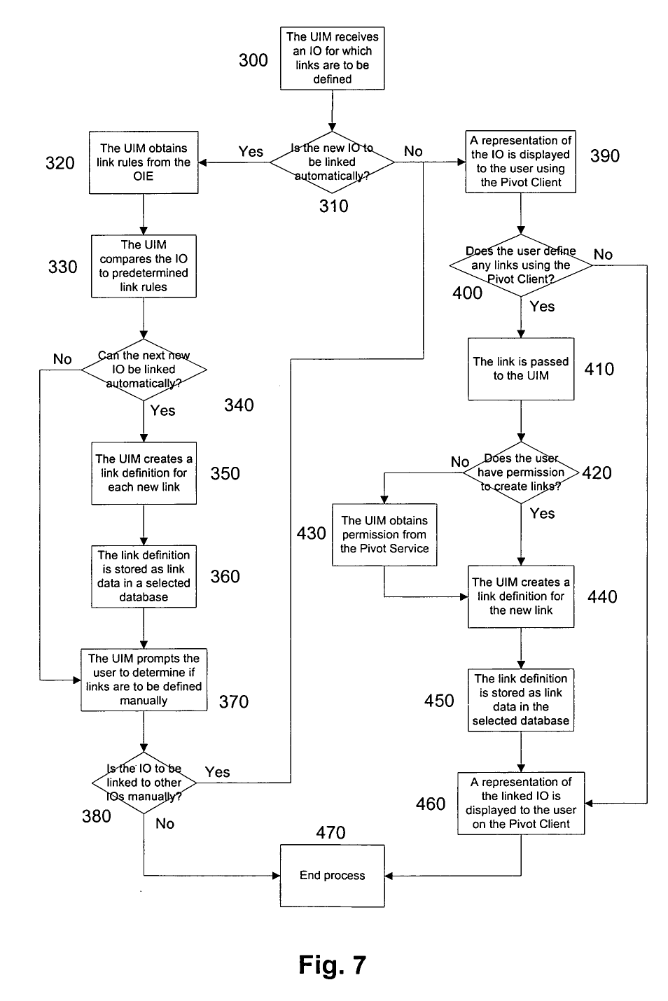

An example of the manner in which links can be defined will now be described with reference to FIG. 7.

Firstly, in order for links to be defined for a given IO, the IO must be received by the UIM 50 at step 300. It will be appreciated, that this typically occurs automatically when the UIM 50 operates to determine the identifier for the IO as described above with respect to FIG. 6.

At step 510, the UIM 50 determines if links are to be defined automatically.

The automatic definition of links requires certain predetermined link rules to be defined within the respective OIE that handles the respective IO type. These link rules can be defined by the respective user, allowing the IOs to be processed in a desired manner. Alternatively, the link rules can be defined by the creator of the respective OIE, allowing various IO types to be handled in a predetermined manner.

Accordingly, if the link rules have not been defined, or if certain predetermined settings are set, then the UIM 50 will proceed straight to manual link definition, at step 390. However, under normal circumstances the UIM 50 will proceed to step 320 to obtain the link rules from the respective OIE.

The link rules will generally specify criteria under which IOs should be linked automatically. This will generally depend on at least one of two main criteria, namely:
The types of the respective IOs; and,
Any predetermined association between the IOs.

Thus the first criteria allows IOs to be linked solely on the basis of the IOs being of predetermined types. For example, if one of the IOs is an e-mail address or the like, it will automatically be linked to an address book IO in accordance with predetermined rules. This ensures that all e-mail addresses are automatically linked to a user's address book.

In contrast the second criteria allows IOs to be linked if there is an additional association between the IOs. Thus for example, if a data object such as e-mail is received, then any IOs contained therein will be automatically linked if they have a predetermined type. Thus for example, the e-mail IO will always automatically be linked to any corresponding e-mail address IOs. This ensures that there is always a link between the sender or recipient e-mail address and the respective e-mail. Similarly, any attachments to the e-mail will also have their respective IOs linked to the IO corresponding to the e-mail.

After comparing the selected IO to predetermined link rules at step 330, the UIM operates to determine if the IO can be linked to any other IOs automatically.

If this is the case, the UIM 50 creates a link definition for each new link at step 350. The information contained in the link definition will vary depending on the respective implementation of the present invention.

However, in this example, the link definition will include at least:
A traversal rule indicating a directionality to the link;
An inheritance indication, indicating whether the traversal can use the identifier of the IO to identify itself to the next pivot
An owner identifier, being the identifier of the owner that created the link;
A traversal allowance indication, indicating which identifiers can perform traversal of the link;
Identifiers of the IOs located at each end of the link (known as source and target identifiers)

The traversal rule specifies directionality to the link. Thus for example, the traversal rule can be used to prevent the link being traversed in a particular direction. Thus for example, the rule may be implemented to allow traversal from a first to a second IO whilst preventing traversal from the second to the first IO.

In addition to this, for example, an e-mail address IO may be defined as being a “child” IO related to a “parent” address book IO. This is because a respective e-mail address is one instance of an address within the address book IO. In addition to this, directionality may be implied because each e-mail address IO could also be linked to a number of different address book IOs. This would allow the identifier of the parent IO to be inherited by the child IO, thereby allowing the parent to be readily identified, and this is provided by the inheritance indication. However, even in this case, settings can be used such that there is no distinction between the IOs and the manner in which they are handled. Accordingly, the parent-child relationship is effectively flattened out such that each IO is equal to each other IO.

The link definition is stored as link data in a selected database. Again, as in the case of identifier storage, the respective database used will depend on the presence of the database within the end station 3. In any event, the database used is generally the same as the database used for storing the identifiers. It will be appreciated that this is performed for each link that may be defined automatically.

Once the link data has been stored at 360 the UIM 50 prompts the user to determine if additional links are to be defined manually at step 370. At step 380, if additional links are to be defined manually, the procedure continues to step 390, as will be described below. Otherwise the process ends at step 470. It will be appreciated from the above description that if the links cannot be defined automatically at step 340 the process will move straight to step 390 to determine if links are to be defined manually.

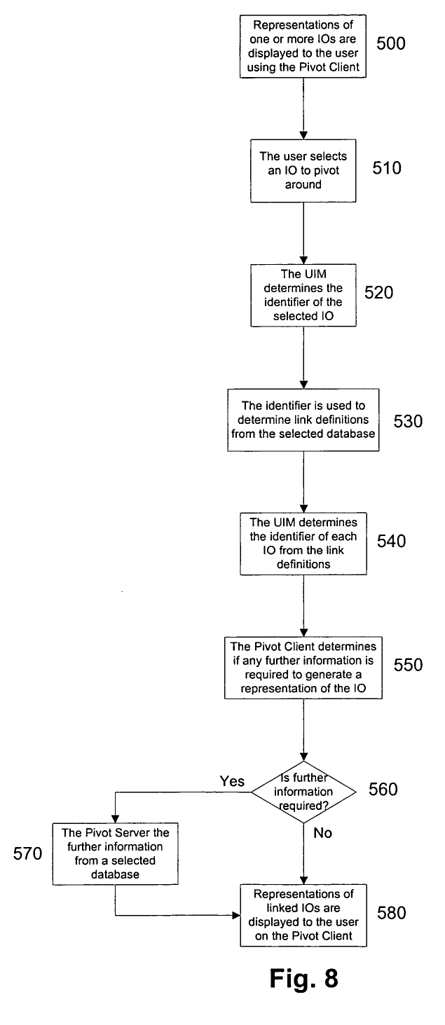

At step 390 a representation of the IO is displayed to the user using the pivot client window 91. The user can then operate to define links between this IO and any other displayed IOs. The other displayed IOs would generally include selected IOs contained in the universe into which the user is adding the new IO, although any suitable IOs could be displayed. Navigation through the IOs contained in the universes will be described in more detail below with respect to FIG. 8.

The manner in which this is achieved will vary depending on the implementation of the pivot client. However, in general this would be achieved by allowing the user to select two of the IOs for example by highlighting the IOs, as shown by the IO selected at 95. The user can then request that a link is defined between the selected IOs. Thus at step 400 the UIM 50 determines if a link is to be defined and if so the link is passed to the UIM 50 from the pivot client at step 410.

At step 420 the UIM 50 operates to determine if the user has permission to create the link. This may occur for example if the user only has viewing rights and is therefore unable to create links to the selected IO.

In this case, the UIM 50 obtains permission to create a link using the pivot service 51. In order to do this, the pivot service 51 queries the authentication service 40 operated by the base station 1. This query will ask the authentication service 40 to provide permission for the user to create the link.

Once permission has been obtained, the UIM 50 then moves on to step 440 to create a link definition representing the link. The link definition is stored in the selected database at step 450 before the link is represented to the user on the pivot client at 460, as will be described in more detail below.

It will be appreciated that the user may be refused permission to create a link. This may occur for example, if a user is attempting to create a link to an IO contained in another user's private universe. In this case, it may still be possible for the links to be defined automatically, but the user will be unable to create further links manually. It will be appreciated that a similar authorisation process may be performed in order for links to be defined automatically.

Once the link or links have been defined, the process ends at step 470.

The manner in which representations of IOs and links can be used to allow users to navigate around the pivot universes will now be described with reference to FIG. 8.

Firstly as shown at step 500, the user will be presented with representations of one or more IOs in the pivot client window 91A, shown in FIG. 5A, or the pivot client windows 91 shown in FIG. 5B.

It will be realised that in order for initial representations to be shown, an indication of the desired IOs must be provided. In general, the representation will be of IOs in a predetermined universe, and accordingly, the user may for example provide an indication of the universe they wish to view to allow the initial representations to be displayed.

Furthermore, as described above, the links may define a parent-child relationship between the IOs. This can be used to define a hierarchy that is used when viewing the universe. As the universe would typically include a large number of IOs, the pivot client will by default display only selected ones of the parent IOs. Thus for example, if the universe includes an address book IO, and a number of address IOs, the pivot client will by default display only the address book IO, allowing the user to navigate to selected ones of the address IOs if required, in the manner described in more detail below.

It is therefore possible for users to configure the pivot client to display not only a selected universe, but also selected ones of the IOs within the universe, when the pivot client is initially activated.

However, this is only achieved upon the selections of appropriate settings, and in any event, the IOs are otherwise treated equally independent of any defined hierarchy, which is typically only used in controlling the display of the IOs.

In any event, once the representations of one or more IOs are displayed, as shown for example in FIGS. 5A and 5B. The user selects an IO to pivot around as shown for example at 95. This is performed at step 510.

At step 520 the identifier of the selected IO is used to determine link definitions from the database. Accordingly, having selected an IO to pivot around the UIM 50 determines the identifier of the respective IO. The identifier is then used to access the link data stored in a selected one of the databases as described above.

In the example in which the link data and identifiers are stored in the database 55, the link data can be obtained by causing the database manager 54 to query the database 55 in accordance with the IO identifier. As the IO identifier will be stored in the link data of each link connected to the IO, this allows the link definition of each link connected with the IO to be determined. Once determined, the link definitions are transferred to the UIM 50.

The UIM 50 then determines the identifier of each IO linked to the selected 10 from the link definition at step 540. Once the identifier of each IO has been determined by the UIM 50, the UIM 50 will cause the pivot client to generate representations of the IOs that are to be displayed.

The representations are generated based on selected information depending on the pivot client itself. Thus, in the example shown in FIGS. 5A and 5B, the representation of each IO is based on the content of the IO. However alternatively, the IO representation could be based on the IO identifier, the IO type, or a predefined IO content indication that is created when the IO is originally defined. The representation used will generally depend on the respective pivot client and any settings on the respective users end station 3.

In any event, at step 550 the pivot client determines if any further information is required to generate a representation for each of the IOs to be displayed. At 560, the pivot client determines if all of the required information is known.

It will be appreciated that if IOs themselves are not located on the end station 3, then the pivot client may only have access to the IO identifier and this may provide insufficient information to generate a representation. Accordingly, at step 570 the pivot client will cause the pivot server to determine the remaining required information from either one of the other end stations 3, the base station 1, one of the servers 5, or one of the databases 12, 12A depending on the storage location of the IO.

As outlined above, the storage location of the IO can be determined based on the identifier, which will allow the creation location of the IO to be determined, which can in turn be used to locate the IO itself. Once this has been completed at 570 the pivot client will proceed to display representations of IOs, joined by the links defined within the associated link definitions. Thus, in the case of FIG. 5A, the pivot client will generate the second pivot window 91B containing the linked IOs as shown. In the case of FIG. 5B, the pivot client will display the IOs in the pivot client windows 91, with the links being shown at 94.

In the case of FIG. 5A, if the user selects one of the IOs in the pivot client window 91B to pivot around, a further pivot client window (not shown) may be created, or alternatively the IOs from the pivot client window 91B may be transferred to the pivot client window 91A, with linked IOs being shown in 91B. It will be appreciated that in the example of FIG. 5A, no OIE window 92 is provided, and accordingly, when a user wishes to edit an IO, the user will select an edit option causing a respective OIE to be launched, for example in a separate application, such as through the use of a third party plug-in application, or the like.

It is also possible for a context to be defined with respect to certain links. Context is defined within the OIE and is defined in terms of relationships between respective IO types. Thus, in the case of an e-mail for example, it is possible to define a sender address IO indicating the e-mail address of the sender and a recipient address IO indicating the e-mail address of the recipient.

In this case, a relationship context can be defined for any recipient or sender address IOs that are linked to any e-mail IOs. Accordingly, each OIE can be adapted to recognise certain forms of relationship. The relationships are defined within the OIE and may be programmer or user defined. The purpose of this is allow context to be applied to links thereby allowing the viewing of links to be filtered.

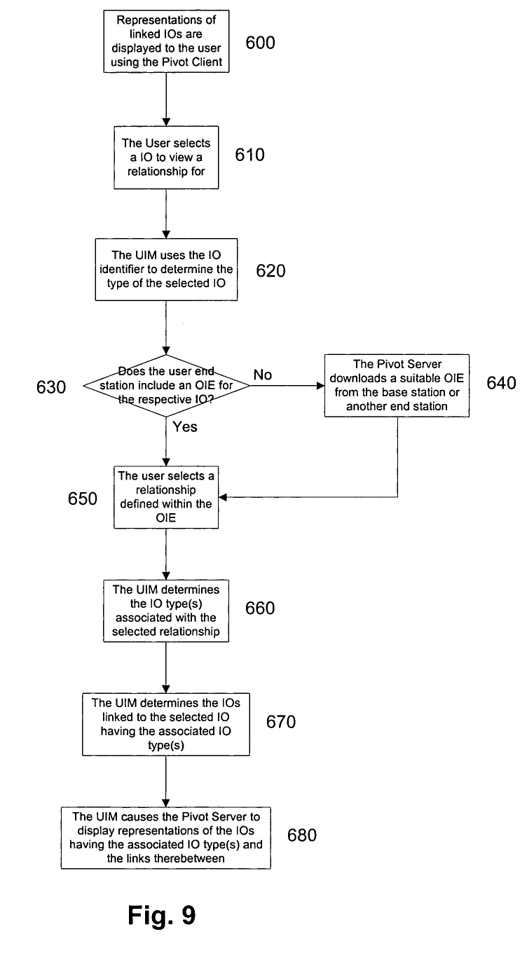

An example of the way in which this can be achieved will now be described with reference to FIG. 9.

In this example, representations of linked IOs are displayed to the user using the pivot client in the normal way, as shown at step 600.

At step 610 the user selects an IO and requests to view an associated relationship. At step 620 the UIM 50 uses the IO identifier to determine the type of the selected IO. At step 630 the UIM 50 determines if the end station includes an OIE to handle the respective type of IO. If not, one is downloaded by the pivot server 51 from either the base station 1, or one of the end stations 3 at step 640.

At step 650 the user then selects a relationship defined within the OIE. The relationship will typically simply define a filter indicating which IO types can form part of the selected relationship. However, alternatively the filter may determine specific IOs, and not just IO types. Once the relationship has been selected at 650 the UIM determines the IOs, or IO types associated with the respective relationship at step 660. The UIM then proceeds to determine the IOs linked to the selected IO and which have the specified IO types at step 670, before causing the pivot client server to display representations of these determined IOs at step 680.

It will therefore be appreciated that rather than show every IO linked to the selected IO, this ensures that only specific IOs, or only IOs having a specific IO type satisfyingly the defined relationship will be displayed.

Thus for example, the user may wish to view e-mails received from a respective individual. Accordingly, the user will select the from sender address IO that represents the respective individuals e-mail address. Simply doing this would normally cause any IOs linked to the sender address IO to be displayed. Accordingly, this would typically include not only the relevant e-mail IOs but also other IOs that are of no interest to the user at this time.

Accordingly, the user selects a “received from” relationship. The “received from” relationship will specify that for a recipient e-mail address IO, the pivot client should display any e-mail type IOs linked thereto. Accordingly, the pivot client will display a list of e-mail type IOs, thereby allowing the user to view the IOs of each e-mail received from the respective individual.

It will be appreciated that this allows users to define their own context to links in the form of respective relationship definitions. The links can then be viewed by any individual who has access to the respective universe containing the IOs. However, the context of the link may only be apparent when the individual also has the respective OIE in which the context is defined. Otherwise, the individual will only know that the IOs are linked but not what the link means.

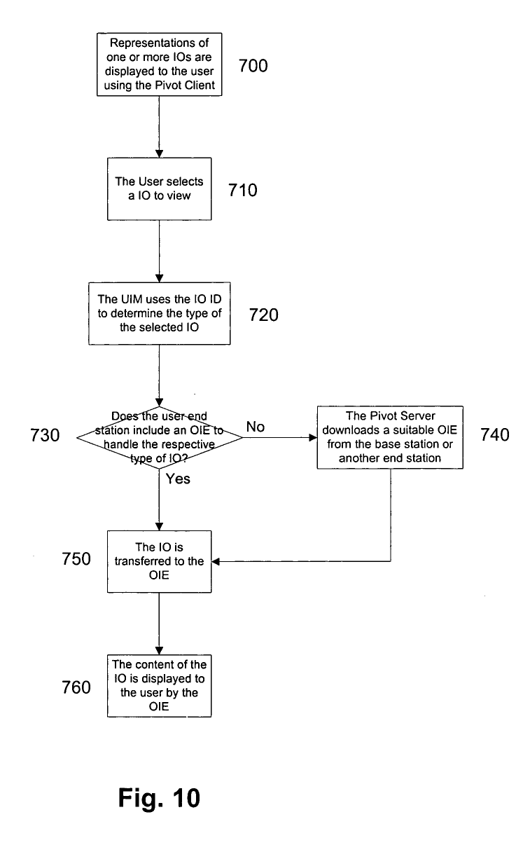

FIG. 10 describes the process via which the content of an IO can be viewed.

In this example, described with respect to FIG. 5B a representation of one or more IOs are displayed to the user in the pivot client window 91 at step 700. The user then selects an IO to view at step 710. At step 720 the UIM 50 uses the identifier of the selected IO to determine the IO type.

The UIM 50 then proceeds to determine if the end station includes an OIE capable of handling the determined IO type. If not a suitable OIE is downloaded at step 740 by the pivot server. The IO is then transferred to the OIE at step 750 allowing the contents to be displayed at step 760.

In this case, if the IO represents an e-mail for example, the UIM will determine if an e-mail OIE is available. If so, the e-mail OIE will be displayed to the user in the OIE window 92, as shown for example in FIG. 5. The content of the IO will then be obtained, typically by download from one of the end stations 3, the base station 1, or one of the databases 12, 12A, 55, before being displayed in the OIE in the fields 97 and the window 98, as appropriate.

Accordingly, it will be appreciated that the above-described system provides for users to be able to create IOs, or define IOs from received or created data objects, as well as to view existing IOs. The IOs can then be linked to other IOs allowing the IOs to be viewed, as well as to allow navigation throughout the universes using the defined links.

This is particularly useful in organising large quantities of data. Thus, for example, by utilising the system described above each time an e-mail is received, this can automatically be used to define associated IOs for the e-mail, any e-mail address or attachments defined therein. As the e-mail IO will automatically be linked to these respective IOs, each time an e-mail is received from a given sender a link will be created between the IOs representative of the sender and the new e-mail. Accordingly, by selecting the sender IO within the pivot universe, this allows each e-mail received from the respective sender to be viewed as a representation on the pivot client. The user can then select a respective one of the e-mails allowing the e-mail content to be viewed using an associated OIE.

It will be appreciated that relationships may then be used to limit the number of e-mails displayed. Thus, for example, e-mails may be received from a sender relating to a number of different topics. A relationship may then be defined for each topic, such that if the user selects a relationship, only e-mails from the sender relating to the relevant topic will be displayed.

In addition to the features described above, a number of additional features may also be implemented.

In particular, as described briefly above an authentication service 40 is provided. The authentication service can be used to authenticate the identifier of users of the system.

Accordingly, each user of the system may be provided with a username and password that is provided to the base station when the user wishes to log-on to the system. The username and password will be stored as user data within the database 12. When a user wishes to log-on to the system, for example to view a universe stored on the base station 1, the user must provide an indication of their respective username and password. The authentication service 40 will use the username to access the user data stored in the database. The authentication service will then compare the received password with the password stored in the user data to ensure that the user is a genuine user of the system.

Once the use has been validated, the user will be able to access any publicly available universes.

However, it is also possible for universe to be defined as private, allowing access to selected individuals only, or to have certain access requirements, such as the payment of a fee. Thus for example, a company may specify that only employees and/or clients of the company may view the IOs within the respective pivot universe. Alternatively, the IOs contained in the universe may only be viewable on a pay-per-view basis or the like.

Accordingly, in this case, access rights indicating access privileges to restricted universes can be stored together with the user data. When the authentication service 40 authenticates a user, the authentication service can also determine the access privileges of the user, and control the viewing and modification of IOs based thereon.

Thus for example, the access rights may indicate that access is granted to a selected pivot view universe for a respective user. The authentication service will then allow the user access to this pivot view universe.

In general access to pivot view universes is restricted by simply preventing a transfer of the identifiers and any link data to an end station 3 for which the user's username and password do not satisfy the access requirements.

In addition to private universes, the base station 1 will also typically store details of public universes that may be viewed by any individuals. An address mapping service is provided to map information objects for example from an individuals private universe into the public pivot universe, as required.

It will be appreciated that companies may want to provide respective universes on a corporate LAN 4. In this case, a respective server 5 may implement the functionality of the base station 1. Alternatively, the IOs, identifiers and other data may be stored in the database 12A, so that these details may not be accessed by end stations 3 not coupled to the respective LAN 4.

Thus, the present invention provides a relationship manager system that allows massive collaboration and data publishing capabilities by automatically building relationships between information owned by users of the system. This in turn allows users to view and access the data using these relationships via the concept of pivots.

Thus, users are allowed to adopt the “point of view” of any information that they have access and permissions to. Every piece of information is related to other pieces information and users. Accordingly the adoption of an information point of view can be a power mechanism for allowing traversing the “universe” of information that is related in anyway.

In order to achieve this, the system generally includes two components:
1. User Interaction Components—which provide the front for the manipulation of information contained within the Pivotview System as well as mechanisms for creation of new information.
2. Core Services—which keep track of Identities within the system and allows for unique Identities to be generated for every information that is encapsulated in the system.

This therefore allows users to interact with information using a free form navigation system (or screen). The user can select any information object within the system assuming the user has the rights to do so.

This will cause all permission-authorised relations with other information will be shown, allowing the user to select other information objects or edit and manipulate the selected object if the user has the permission to do so.

It will be appreciated by persons skilled in the art that numerous variations and modifications will become apparent. All such variations and modifications which become apparent to persons skilled in the art, should be considered to fall within the spirit and scope of the invention as broadly hereinbefore described.

### Appendix A

Authentication Service

The authentication between the pivot server 51, 61, 71 and the identifier service or other pivot servers is implemented using encryption technology such as PGP encryption.

The program flow for authentication between the pivot server and the identifier service is as follows:
Pivot server establishes a connection to Identity Service.
Pivot Server will issue it's identifier key.
Identity Service will issue a challenge phrase encrypted with Pivot Public Key.
Pivot Server will decrypt challenge phrase with Pivot Private Key.
Pivot Server will encrypt challenge phrase with Identity Service Public Key.
Identity Service will decrypt challenge phrase with Identity Service Private Key.
If challenge phrase matches, Pivot Server is authenticated.

The program flow for authentication between pivot servers is as follows:
Pivot establishes a connection to Identity Service.
Pivot authenticates itself to Identity service.
Identity service notice target pivot server of an incoming connection request and issue a session key to both servers.
Target pivot server will make a connection to Originating pivot server with session key.
Connection will be kept alive until idle for 5 minutes.

### Appendix B

Identifier Generation

Each Identifier is a unique number that consists of 4 major parts broken down into 2 subparts of 32 bits in length.

Each Identifier is 32×8 bits in length, broken down as follows:

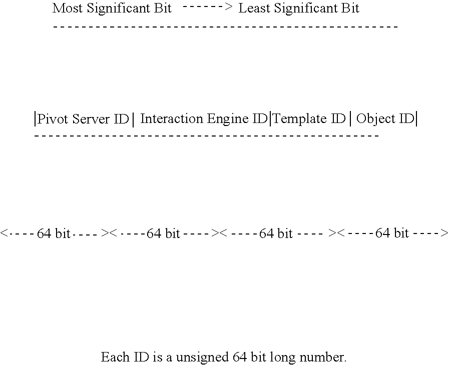

Control is as follows:
Pivot Server ID is issued by Identity Services
Interaction Engine ID is issued by Pivot Services
Template ID and Object ID is issued by Interaction Engines

The Identity Bits are further broken down as follows:
Pivot Server ID 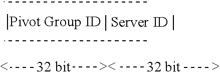
Interaction Engine ID 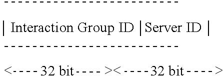
Interaction Group ID is an ID that uniquely identifies a specific data service.
This ID will be manually administrated. It will be issued to developers who want to build applications that talk to pivot servers.
   Template ID 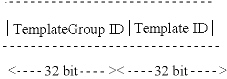
This is the object template (type) identity that will uniquely identify each object type.
   Object ID

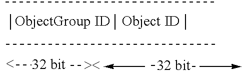

The manner in which the identifiers are obtained will now be summarised below:

Registration of Pivot Servers

Upon 1st running a pivot server, pivot server will startup and perform initialization. The Pivot server should know that it has not been successfully issued with an identifier.
A pivot server will register itself with the nearest Identity Service available.
The pivot server will then obtain a unique ID (Pivot Server ID) and confirm acceptance.
The Identity Service will issue a certificate that the pivot server will use to authenticate itself. This certificate can come in the form of a Veri-Signed cert or any Industry Standard certification.
   Registration of Interaction Engines
Upon installation of IE modules, the pivot server will issue a Server ID based on it's Interaction Group ID if the following holds.
The pivot server will perform a check to see whether the plug-in contains a signed certificate equivalent to one located at the Identity Service.
This will make sure that the IE modules are authenticated before installation.
   Registration of Template ID's and Object ID's
The Template ID and Object ID are entirely the responsibility of the developers of the IEs (Interaction Engines).

1) A method of using a processor to create a linked information object, the processor being coupled to a display and a store, each information object being formed from content having a respective type, the method including causing the processor to:
a) Obtain an information object;
b) Assign a unique identifier to the information object in accordance with the information object type, the information object type being based on the type of the content;
c) Define one or more links between the information object and one or more other information objects, the links being defined using at least one of:
i) Predetermined rules; and,
ii) Input commands from a user;
d) Generate link data defining the one or more links; and,
e) Store the link data in the store.

2) A method according to claim 1, the method of obtaining the information object including causing the processor to obtain an information object by determining a new information object from a data object by:
a) Obtaining the data object, the data object including one or more content type instances;
b) Determining a content type instance from the data object;
c) Comparing the content type instance to existing information objects; and,
d) Determining the content type instance to be a new information object in response to an unsuccessful comparison.

3) A method according to claim 2, wherein if the data object contains two or more information objects, the method of defining the one or more links between the information object and one or more other information objects includes defining links between the information objects contained in the data object.

4) A method according to claim 1, the method of defining the one or more links between the information object and the other information objects, including causing the processor to:
a) Compare the information object type of the information object with the information object type of each other information object in accordance with predetermined rules; and,
b) Define a link between the information object and one of the other information object in accordance with a successful comparison.

5) A method according to claim 4, the predetermined rules specifying for each information object type respective conditions that must be satisfied in order to allow the link to be defined with other information object types.

6) A method according to claim 5, one of the conditions including that a link is defined between two information objects having respective first and second information object types if the content of one of the information objects is formed from a portion of the content of the other information object.

7) A method according to claim 1, the method of defining the one or more links between the information object and one or more other information objects, including causing the processor to:
a) Display a representation of the information objects to the user;
b) Allow the user to use an input to select at least two of the information objects; and,
c) Define a link between the selected information objects.

8) A method according to claim 7, the method of displaying a representation to the user including causing the processor to:
a) Determine the identifiers of any information objects to be displayed;
b) Determine any links between the information objects, the links being determined in accordance with the determined identifiers and the link data; and,
c) Generate a representation of the information objects by:
i) Generating a representation of each information object based on at least one of the information object type and the information object content; and,
ii) Generating a representation of the determined links between the information object representations.

9) A method according to claim 8, the representation being formed from a tree type representation, with the information object representations being arranged in accordance with the determined links.

10) A method according to claim 9, the information object identifier further including an indication of the respective processing system on which the information object was determined.

11) A method according to claim 1, the processor being adapted to execute information object processing applications software adapted to allow user to process selected information object types, the method including causing the processing application to perform at least one of the following processes:
a) Define new information objects; and,
b) View the contents of selected information objects.

12) A method according to claim 11, the processor being adapted to execute display application software adapted to display information objects.

13) A method according to claim 12, the processor being adapted to execute control application software adapted to cooperate with the display software and one or more of the processing applications.

14) A method according to claim 13, the method including controlling the determination of new information objects by causing the control application to:
a) Obtain the data object;
b) Determine the content type of one or more content instances from the data object; and,
c) Transfer the information object to a processing application adapted to process the determined content type.

15) A method according to claim 13, the method including controlling the determination of the identifiers by causing the control application to:
a) Obtain a new information object from a respective processing application; and,
b) Generate the identifier in accordance with predetermined rules, and in accordance with the information object type.

16) A method according to claim 13, the method further including causing the control application to perform at least one of:
a) Defining the links between information objects;
b) Transferring the information objects to the display application to cause the information objects to be displayed; and,
c) Obtaining processing applications to allow different information object types to be processed.

17) A method according to claim 11, the method further including define relationships, each relationship defining a context for links between specified information object types, each relationship being defined by causing a respective processing application to:
a) Allow a user to select two or more object types;
b) Allow the user to specify a relationship for links between the selected object types; and,
c) Store an indication of the relationship as relationship data.

18) A processing system for creating a linked information object, the processing system including:
a) A display;
b) A store;
c) A processor adapted to perform the method of claim 1.

19) A method of using a processor to handle linked information objects, the processor being coupled to a display, a store and an input, each information object being formed from content having a respective type, the links between the information objects being defined by link data stored in the store, the method including causing the processor to:
a) Generate a representation of a number of information objects, the representation being displayed to the user on the display;
b) Allow the user to use the input to select one of the information objects;
c) Determine one or more other information objects linked to the selected information object in accordance with the link data; and,
d) Generate a representation of the selected information object and at least the linked information objects, the representation being displayed on the display.

20) A method according to claim 19, the method further including causing the processor to generate the representation by:
a) Determining the identifier of the selected information object;
b) Determining the links between the selected information object and the linked information objects, the links being determined in accordance with the determined identifier and the link data; and,
c) Generating the representation by:
i) Generating a representation of each information object based on at least one of the information object type and the information object content; and,
ii) Generating a representation of the determined links between the information object representations.

21) A method according to claim 19, the representation being formed from a tree type representation, with the information object representations being arranged in accordance with the determined links.

22) A method according to claim 19, the processor being further adapted to display the content of an information object to be displayed on the display in response to a request from a user.

23) A method according to claim 19, the processor, the display, the store and the input forming part of a processing system, the processing system being adapted to be coupled to one or more other processing systems via a communications network, the method including causing the processor to obtain required data from other ones of the processing systems, the required data including at least one of:
a) Information objects;
b) Link data; and,
c) Information object identifiers.

24) A method according to claim 23, the identifiers including an indication of the processing system on which the identifier is stored, the method further including causing the processor to:
a) Determine the processing system on which the required data is stored; and,
b) Obtain the required data therefrom.

25) A method according to claim 19, the link data specifying the identifiers of each linked information object for each respective link, the method further including causing the processor to determine the identifier of a linked information object to be obtained from the link data.

26) A method according to claim 19, the processor being adapted to execute information object processing applications software adapted to allow user to process selected information object types, the method including causing the processing application to perform at least one of the following processes:
a) Define new information objects; and,
b) View the contents of selected information objects.

27) A method according to claim 26, the processor being adapted to execute display application software adapted to display information objects.

28) A method according to claim 27, the processor being adapted to execute control application software adapted to cooperate with the display software and one or more of the processing applications.

29) A method according to claim 28, the method including controlling the generation of a representation of information objects linked to a selected information object by causing the control application to:
a) Determine the link data representing the respective links in accordance with the identifier of the selected information object;
b) Determine the identifiers of each linked information object from the link data; and,
c) Transfer an indication of the links and the identifiers to the display application.

30) A method according to claim 28, the method including controlling the display of the content of a selected information object by causing the control application to:
a) Determine the identifier of the selected information object;
b) Determine if the selected information object is in the store; and,
i) If not;
(1) Determine the processing system from which the information object can be obtained; and,
(2) Causing the processing system to obtain the information object from the determined processing system;
ii) Otherwise obtain the information object from the store; and,
c) Transfer the information object to a selected processing application, the processing application operating to display the contents of the application.

31) A method according to claim 29, the processing application being further adapted to define relationships, each relationship defining a context for links between specified information object types, the method including:
a) Allowing a user to select a relationship type; and,
b) Controlling the generation of the representation such that only links satisfying the selected relationship are displayed.

32) A method according to claim 28, the method further including causing the control application to:
a) Determine the information object type from the respective identifier;
b) Determine if any processing applications executable by the processor can process the determined information object type; and,
c) Causing the processor to obtain a new processing application from one of the other processing systems via the communications systems in response to an unsuccessful comparison.

33) A method according to claim 19 the linked information objects being created using a method of using a processor to create a linked information object, the processor being coupled to a display and a store, each information object being formed from content having a respective type, the method including causing the processor to:
a) Obtain an information object;
b) Assign a unique identifier to the information object in accordance with the information object type, the information object type being based on the type of the content;
c) Define one or more links between the information object and one or more other information objects, the links being defined using at least one of:
i) Predetermined rules; and,
ii) Input commands from a user;
d) Generate link data defining the one or more links; and,
e) Store the link data in the store.

34) A processing system for handling linked information objects, the processing system including:
a) A display;
b) A store;
c) A processor adapted to perform the method of claim 19.
